(19) United States
(12) Patent Application Publication
(10) Pub. No.: US 2007/0226543 A1
(43) Pub. Date: Sep. 27, 2007

(54) User customizable expert system for communications testing

(76) Inventors: Jerry L. Young, Gresham, OR (US); Larry J. Huff, Scappose, OR (US); Thomas A. Elliott, Tigard, OR (US)

Correspondence Address: MATTHEW D. RABDAU;TEKTRONIX, INC., 14150 S.W. KARL BRAUN DRIVE, P.O. BOX 500 (50-LAW), BEAVERTON, OR, 97077-0001, US

(21) Appl. No.: 11/441,671

(22) Filed: May 25, 2006

Related U.S. Application Data
(60) Provisional application No. 60/785,793, filed on Mar. 24, 2006.

(51) Int. Cl. G06F 11/00

(52) U.S. Cl. 714/43

(57) ABSTRACT

A user customizable expert system for communications testing has an Editor program for creating a test package file by an expert for transferral to a measurement instrument, and a Player program for running the test package file on the measurement instrument according to a guide provided to a technician. The guide includes text and graphics to assist the technician in setting up and running a selected test measurement, as well as troubleshooting hints when measurement results indicate a problem. The Player program also generates test results source files that include test results as well as user comments regarding corrective actions taken with respect to problems on a per-test-run basis. The test results source files may be transmitted back to the expert for archival, analysis and use in modifying the test procedure as necessary.

### CROSS-REFERENCE

This application claims the benefit of U.S. provisional application No. 60/785,793 filed Mar. 24, 2006.

### BACKGROUND OF THE INVENTION

The present invention relates to the testing of communications systems, and more particularly to a user customizable expert system that provides consistent, repeatable and accurate testing procedures for inexperienced test instrument operators.

Communications system operators want simple, uniform testing procedures that enable technicians to locate and resolve equipment problems, such as in a base test station (BTS). Operators may purchase field test instruments, such as the Tektronix® NetTek® Y400 Analyzer Platform (handheld) with appropriate measurement modules, but often don't use them to the fullest extent because they do not feel confident that most technicians know how to use such instruments without extensive training. Further operators may move from one technology to a newer technology, such as from 2G GSM technology to 3G UMTS technology, and desire to use current test instruments for testing the newer technology. Finally the operators want to share troubleshooting knowledge among their technicians, and ensure that the technicians are testing the BTS correctly.

Test instruments that currently are in the field and that use a guided test concept are specific for a particular communication technology and/or equipment. There is no allowance for customizing by the operator according to particular operation needs, or when equipment is changed or newer technology is adopted.

What is desired is a user customizable expert system for making guided, repeatable testing easy in order to enhance the productivity of technicians using existing test instruments to perform the testing.

### BRIEF SUMMARY OF THE INVENTION

Accordingly the present invention provides a user customizable expert system for communications testing that has an Editor program for creating a test package file by an expert for transferral to an existing measurement instrument, and a Player program for running the test package file on the measurement instrument by a technician according to guidance within the test package file. The expert uses the Editor program, such as on a personal computer, to create the test package file by specifying particular measurements to be run, providing guidance on how to set up the measurement instrument and the equipment being tested in order to run the particular measurements, and providing troubleshooting hints to assist the technician in correcting any problems detected during the running of the particular measurements. Text and pictures may be included in the test package file. The test package file may then be transferred to the measurement instrument by any suitable means, including via a network, a flash card or the like. Once loaded into the measurement instrument, the technician may then run any of the measurements according to the expert guidance provided in the test package file. Once the measurements are completed, the results may be compiled in a report that is then transferred back to the expert via similar transferral techniques. Any problems encountered may be included in the report, as well as any steps taken by the technician to correct such problems. The expert may then review the report and update the test package file as necessary for future measurements. In this way experts control what measurements are executed and guide the field technicians on issues of troubleshooting and equipment setup without the technicians having to take any supplemental materials or equipment into the field or requiring extensive training on the measurement instrument.

The objects, advantages and other novel features of the present invention are apparent from the following detailed description when read in conjunction with the appended claims and attached drawing.

### BRIEF DESCRIPTION OF THE SEVERAL VIEWS OF THE DRAWING

FIG. 1 is an architectural diagram view of a user customizable expert system according to the present invention.

FIG. 2 is a flow diagram view for an Editor program for the user customizable expert system according to the present invention.

FIG. 3 is a plan view of a display for starting the Editor program according to the present invention.

FIG. 4 is a plan view of a channel signal and signal standard select display for the Editor program according to the present invention.

FIG. 5 is a table view of defined functions for selecting test steps in a test procedure according to the present invention.

FIG. 6 is a plan view of a dialog create display according to the present invention.

FIG. 7 is a plan view of an interface screen for the Editor program according to the present invention.

FIG. 8 is a plan view of a display for selecting measurement parameters according to the present invention.

FIG. 9 is a plan view of a measurement help display according to the present invention.

FIG. 10 is a flow diagram view of a Player program according to the present invention.

FIG. 11 is a plan view of a setup display according to the present invention.

FIG. 12 is a plan view of channel/frequency select display according to the present invention.

FIG. 13 is a plan view of a measurement results display according to the present invention.

FIG. 14 is a plan view of a help display for troubleshooting according to the present invention.

FIG. 15 is a plan view of a results display according to the present invention.

### DETAILED DESCRIPTION OF THE INVENTION

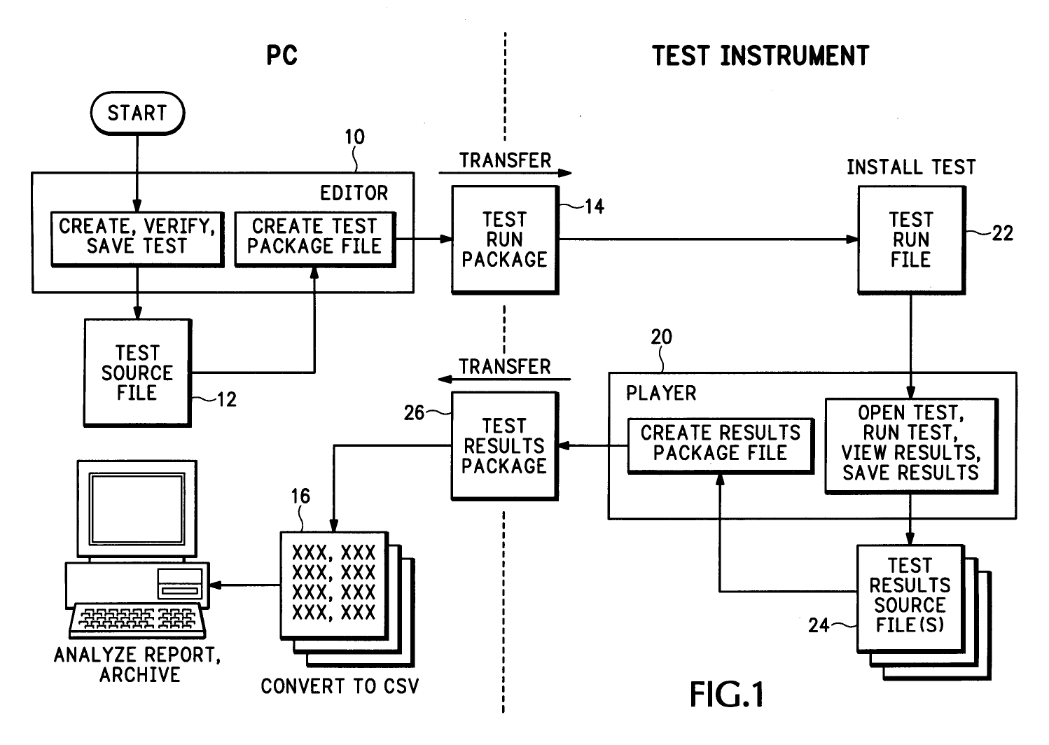

Referring now to FIG. 1 an architecture is shown for a user customizable expert system. The architecture has two separate applications—an Editor program 10 and a Player program 20. A senior technician, experienced engineer or other expert of a communications system operator uses the Editor program to create a test source file 12. Once the expert is satisfied with the contents of the test source file 12, a test package file is created. The test package file is then transferred as a test run package 14 from the PC to a test instrument via any convenient means, such as downloading from a network, wired or wireless, using RS-232, USB, Internet, Ethernet or the like, loading from a flash card (PCMCIA memory card), etc. and saved as a test run file 22. The Editor may be installed on a conventional personal computer (PC) situated at a desk in an office.

Once loaded in the test instrument a technician, who may not be especially skilled, runs the test run file 22 using the Player program to produce test results source files 24. From the test results source files 24 a test results package 26 is created and transferred back to the PC directly or indirectly (in the same manner as transferring the test package file). The test results package 26 is converted to an appropriate report format 16 for archival, analysis and use by the expert in modifying the test procedures in the test source file 12 as necessary.

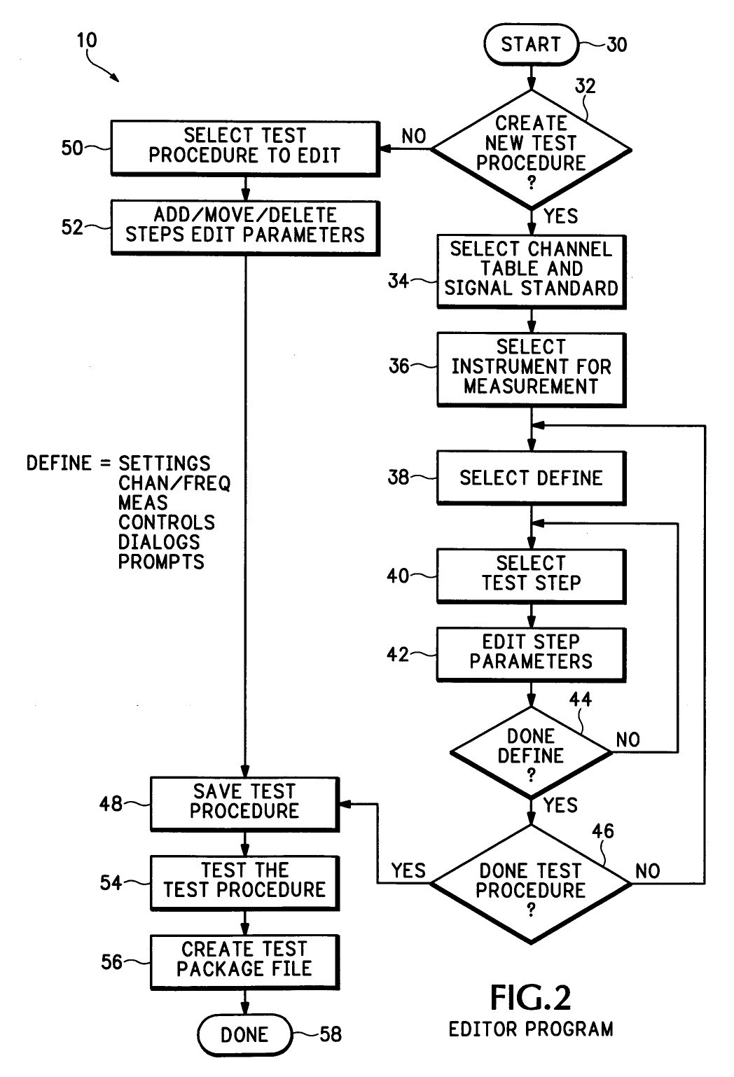

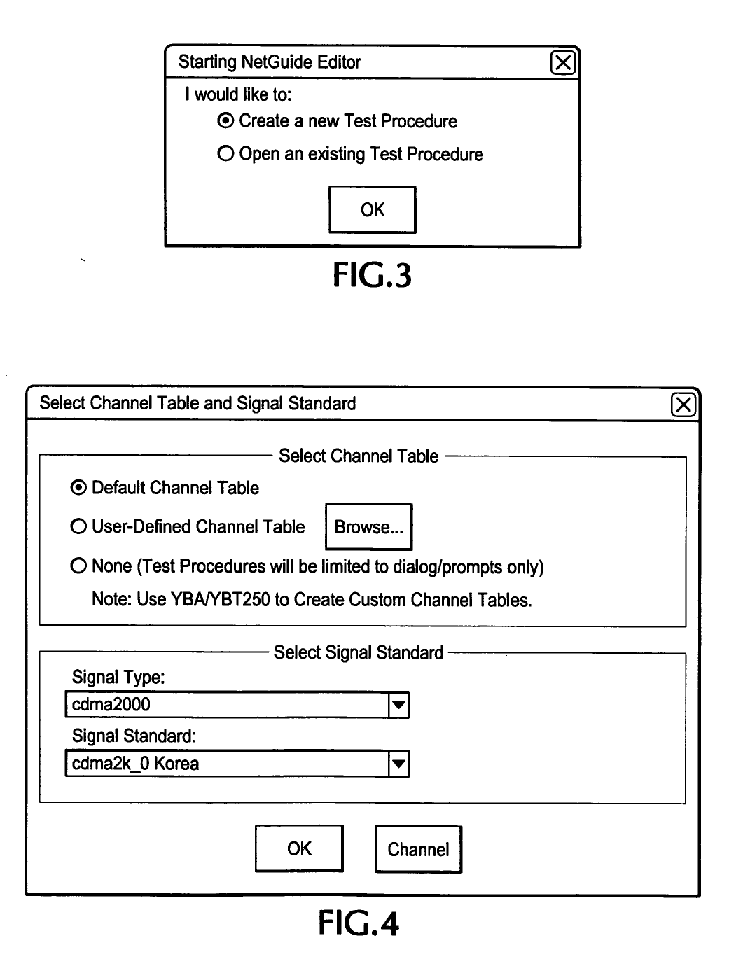

As an example it may be desired to create a test procedure for the cdma2000 signal standard. The test procedure includes connection instructions for the test instrument and the equipment being tested, asks the technician to enter RF channels to test, and then makes the RF power and signal quality measurements. Referring now to FIG. 2 the expert starts (step 30) the Editor program 10 and is given a choice (step 32) between creating a new test procedure or opening an existing test procedure, as shown in FIG. 3. The expert then selects a channel table and signal standard (step 34), as shown in FIG. 4 where a default channel table and the cdma2000 signal standards are selected. The expert selects the instrument to perform the measurements (step 36), i.e., into which the final test procedure will be loaded, selects particular parameters for definition (step 38), such as settings, channel/frequency, measurement, controls, dialogs, prompts, etc., selects the test step to perform (step 40) and edits the test step parameters (step 42) to complete the definition. If the particular definition is not done (step 44), then the test step and parameter editing steps 40, 42 are repeated until the particular definition is complete. When all the parameters for the test procedure are defined (step 46), the test procedure is saved (step 48), otherwise control is returned to the select definition step 38 and the process repeated until the test procedure is complete.

If the desire is to modify or edit an existing test procedure, then control passes to step 50 to select the test procedure to be modified. The test procedures steps may be added/moved/deleted and parameters edited as in creating a new test procedure (step 52), and the edited test procedure is then saved (step 48).

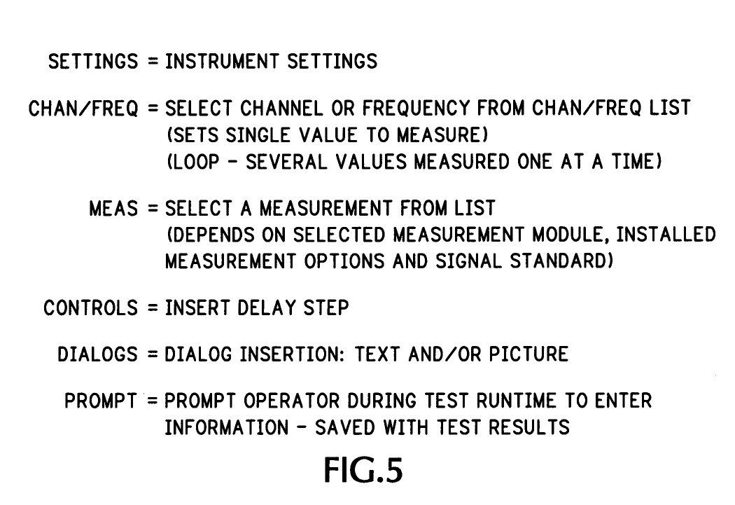

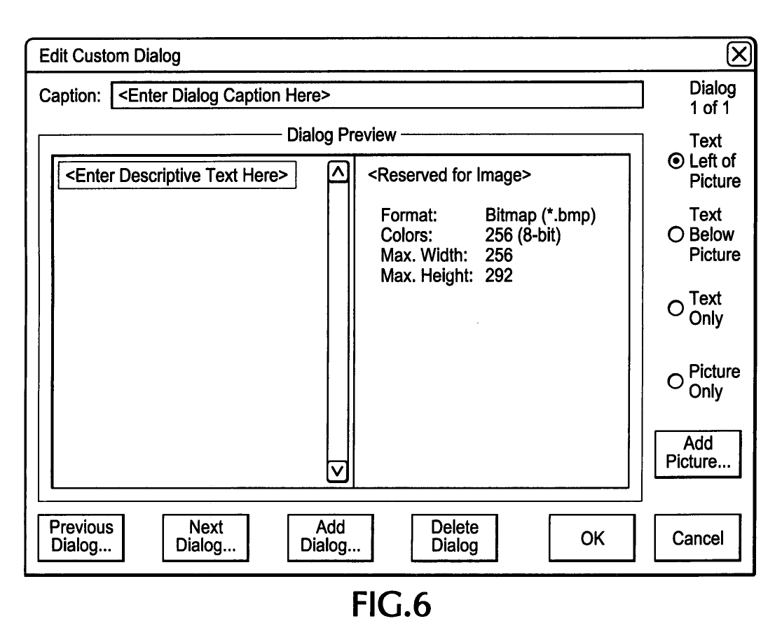

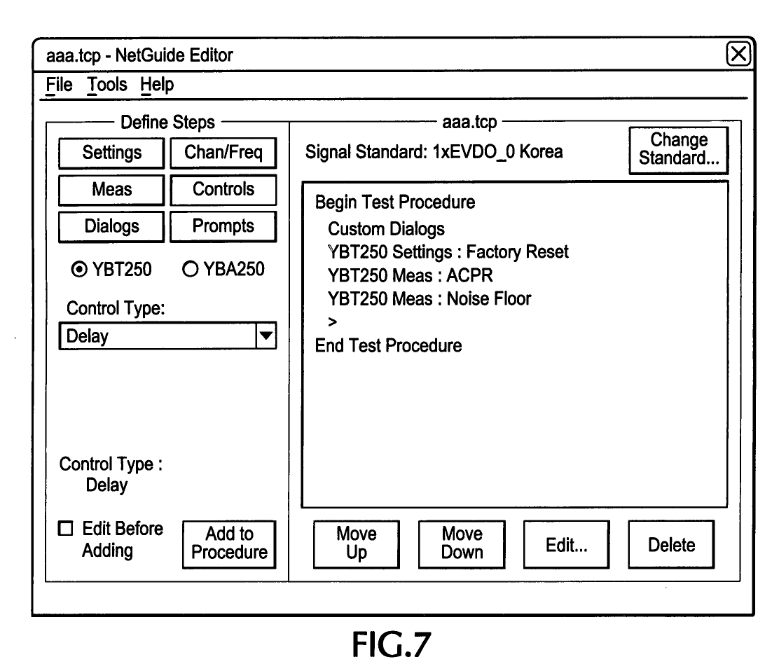

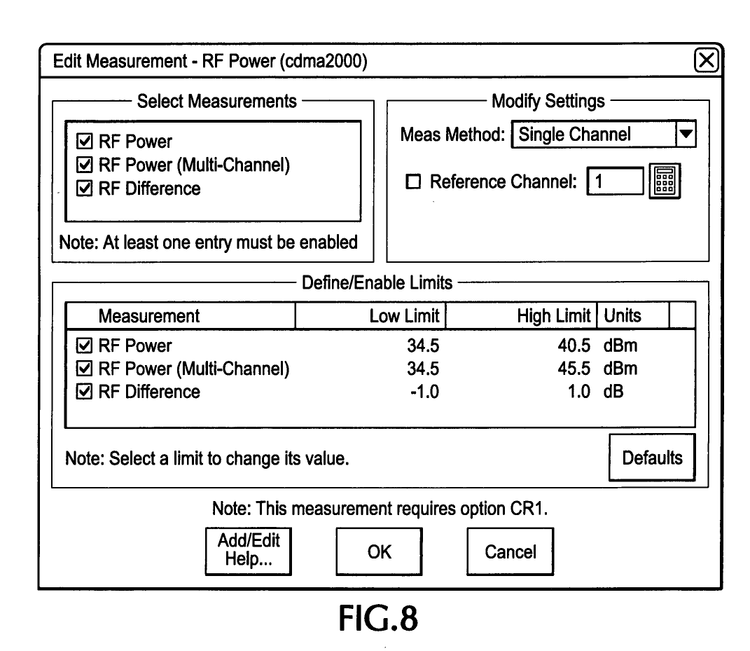

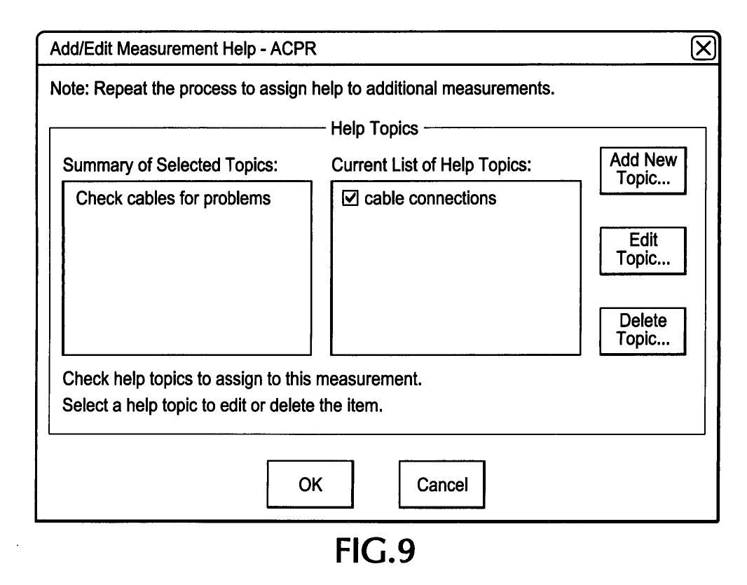

Controls are provided to move and edit procedure elements, i.e., the configuration of individual measurements. The control and measurements may be separated into definitions, as shown in FIG. 5. For example to add a dialog the “dialog” function is selected, and a dialog box opens. At this point additional data, such as text and pictures, may be added; and then OK is pressed when complete, as shown in FIG. 6. The additional data may also include audio and video, depending upon storage capabilities. Likewise queries may be added to request the user to select a particular channel/frequency (FIG. 7). Further measurements may be added. When a measurement is selected, RF power limits may be defined and enabled for limit testing, and settings modified specific to the measurement, as shown in FIG. 8. Finally “help” topics may be created just like dialogs for the specific measurement (FIG. 9). The resulting test procedure is saved for future use, as indicated at step 48. The test procedure may be tested (step 54) and, if not satisfactory, may be modified as described above. The test procedure is saved as the test source file 12, shown in FIG. 1. From the test source file an appropriate test package file is created and packaged for distribution, either via a flash card, over a network, or the like as described above (step 56), and the Editor exits (step 58).

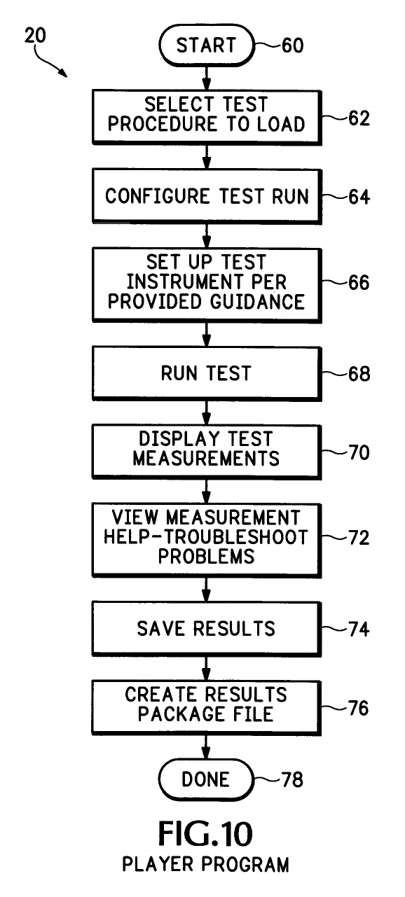

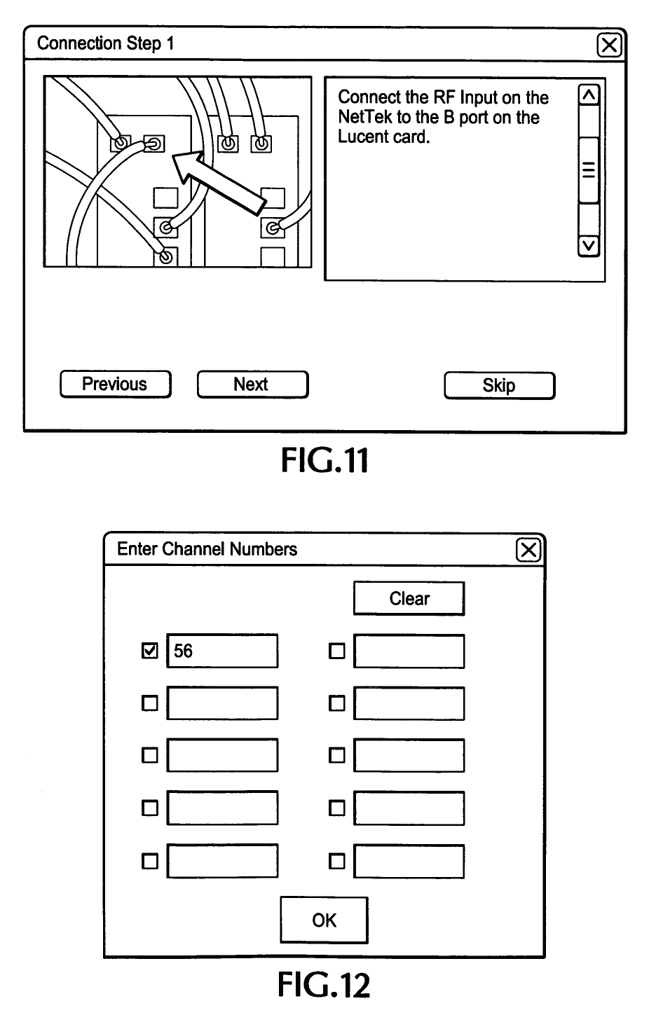

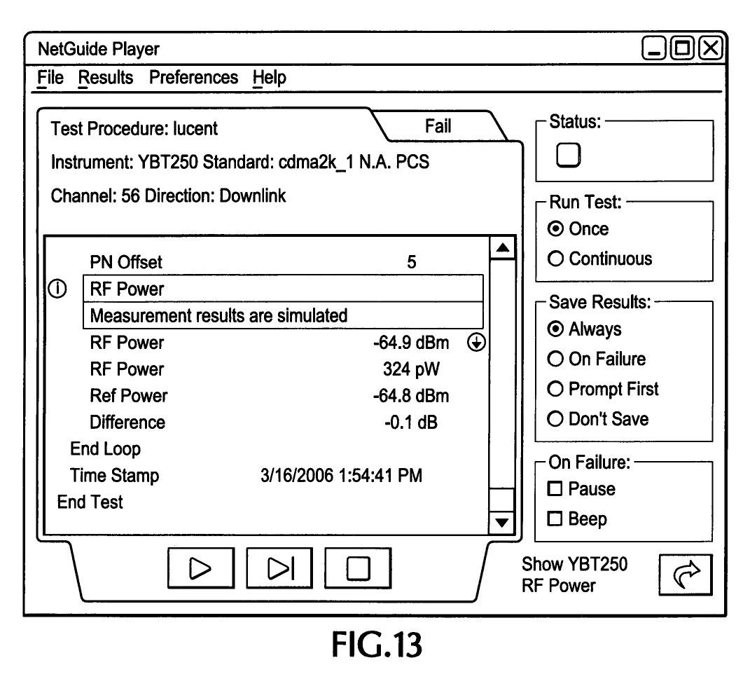

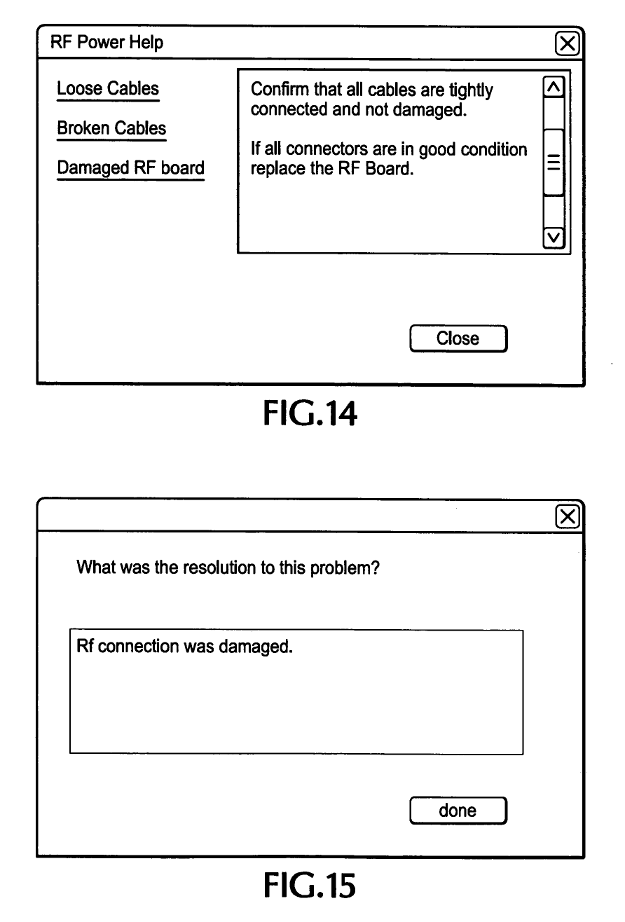

Once loaded on the test instrument the test procedure is run using the Player program 20, as shown in FIG. 10. The technician starts the Player program (step 60) and the desired test procedure is selected (step 62). The technician is guided through equipment setup, using both using the multimedia data (steps 64, 66) as shown in FIG. 11. Pages are taken in sequence to assure the correct connections are made before measurements are taken. The technician is asked what RF channels to test (FIG. 12). When the setup is complete, the test procedure is run and the measurement results are shown live on the test instrument display (FIG. 13). During the running of the test procedure the technician may interact with the test procedure when the test procedure asks for it, i.e, the test procedure may pause and tell the technician to verify that a particular connection is “ok” before continuing. The technician may touch the “help” icon for customized help. Also the color of the results may indicate a pass/fail/marginal condition. Once the setup is complete, the test procedure is run (step 68), as indicated above, and the measurement results are displayed (step 70). By touching a particular measurement result, the details may be shown. If the measurement result indicates failure, then the customized help (step 72) leads the user to various troubleshooting steps, as shown in FIG. 14. The measurement results and steps taken by the technician to resolve any failure (step 74) (FIG. 15) are recorded in the test results source files 24 on a per-test-run basis for subsequent transfer back to the PC at the expert's desk as the results package file 26 (step 76). The technician then exits the Player program (step 78).

The communications system operator now has the ability to create its own measurement test sequences, rather than being dependent upon a provided, rigid test sequence or a test specific instrument, and to print reports based on the testing for sharing with other groups. The technician no longer has to spend an inordinate amount of time in training to use the test instrument, and does not need to carry additional items such as a laptop computer or notebook. The result is increased technician productivity, since guides are created to help troubleshoot or configure the BTS for test, and the sharing of knowledge among technicians.

Thus the present invention provides a user customizable expert system for testing a communications system that has an Editor program for creation of a test procedure by an expert and a Player program in a test instrument for running the test procedure in a guided mode, providing troubleshooting advice when tests fail.

What is claimed is:

1. A user customizable expert system for testing communications systems comprising:
an editor at a source to create a test procedure that is tailored to a particular communications system using input from an expert, the test procedure including additional data to provide a guide to a user in setting up and running the test procedure;
a first interface coupled to the editor to transfer the test procedure to a measurement instrument; and
a player at the measurement instrument to allow the user to run the test procedure according to the guide provided as part of the test procedure to produce measurement results.

2. The expert system as recited in claim 1 further comprising a second interface to transfer the measurement results from the measurement instrument to the source for archival, analysis and use in modifying the test procedure as necessary.

3. The expert system as recited in claim 2 wherein the editor includes means for editing the test procedure as deemed necessary by the expert.

4. A method of testing a communications system comprising the steps of:
creating at a source a test procedure tailored to the communications system using input from an expert, the test procedure including additional data to provide a guide to a user in setting up and running the test procedure;
transferring the test procedure from the source to a measurement instrument; and
running the test procedure by the user with the measurement instrument according to the guide.

5. The method as recited in claim 4 further comprising the step of transferring results generated by the running step from the measurement instrument to the source for archival, analysis and use in modifying the test procedure as necessary.

6. The method as recited in claim 5 wherein the creating step includes editing the test procedure as deemed necessary by the expert.

7. The method as recited in claim 4 wherein the creating step comprises the steps of:
selecting a channel table and standard to use for testing the communications system;
selecting the measurement instrument to perform the test procedure;
defining the steps and parameters for the test procedure, including the additional data;
saving the test procedure in a test source file; and
generating from the test source file a test package file containing the test procedure for transferral by the transferring step.

8. The method as recited in claim 7 wherein the creating step further comprises the step of using the test source file to test the test procedure prior to the generating step.

9. The method as recited in claim 7 wherein the creating step further comprises the steps of:
selecting an existing test procedure for editing; and
editing the existing test procedure prior to the saving step.

10. The method as recited in claim 4 wherein the running step comprises the steps of:
selecting at the measurement instrument the test procedure to be run;
configuring the measurement instrument and equipment being tested according to the guide;
executing the test procedure; and
displaying test measurement results produced by the executing step.

11. The method as recited in claim 10 wherein the running step further comprises the steps of:
troubleshooting the equipment being tested according to the guide when the test measurement results indicate a problem; and
saving the test measurement results and steps taken by the user in resolving the problem in a test results source file for each test run.

12. The method as recited in claim 11 wherein the running step further comprises the step of generating from the test results source files a test results package for transferral to the source.
